(19) United States
(12) Patent Application Publication
(10) Pub. No.: US 2016/0144888 A1
(43) Pub. Date: May 26, 2016

(54) PLAY COMPENSATION FOR A PINION BEARING

(71) Applicant: THYSSENKRUPP PRESTA AG, Eschen (LI)

(72) Inventors: Aksel MAIER, Plüderhausen (DE); Kai VOHWINKEL, Reichenbach (DE); Christine GOLDBERG, Deizisau (DE); Anatoli SCHRÖDER, Ludwigsburg (DE)

(73) Assignee: THYSSENKRUPP PRESTA AG, Eschen (LI)

(21) Appl. No.: 14/899,437

(22) PCT Filed: Jun. 18, 2014
(86) PCT No.: PCT/EP2014/062810

§ 371 Date: Dec. 17, 2015

(30) Foreign Application Priority Data
Jun. 21, 2013 (DE) 102013010361.4

(51) Int. Cl. B62D 3/12; F16H 55/28; F16H 57/022; F16C 25/08

(52) U.S. Cl. CPC B62D 3/123; F16C 25/083; F16H 55/283; F16H 57/022; F16H 2057/0222

(57) ABSTRACT

A rack and pinion drive may comprise a housing without a thrust piece connector, as well as a toothed rack that has a toothing arrangement and is slidably mounted in the housing. A pinion may be rotatably mounted in a bearing in the housing, wherein the pinion is positioned along a longitudinal axis. The pinion may have a toothing arrangement that engages with the toothing arrangement of the toothed rack. A bearing arrangement for mounting the bearing in the housing may include a guide piece that abuts the housing and has an internal guide face. Likewise, the bearing arrangement may include a sliding piece that surrounds the bearing and has an external guide face. The external guide face of the sliding piece is guided at least by the internal guide face of the guide piece such that the sliding piece is slidable at least in a direction of the longitudinal axis. As a result, the pinion is adjustable in a direction of the toothed rack.

The present invention relates to a rack and pinion drive according to the preamble of claim 1.

Such rack and pinion steering systems have been known for a relatively long time from the prior art. In these steering systems, the toothed rack is slidably guided in the longitudinal direction in a steering housing. A pinion which is rotatably mounted in the steering housing engages in the toothing arrangement of the toothed rack and, in the event of rotation of the steering column which is connected in a rotationally fixed fashion to the pinion, brings about the lateral displacement of the toothed rack, which in turn brings about pivoting of the steered wheels of the motor vehicle via steering track rods and steering knuckles.

The engagement of the toothing arrangement between the pinion and the toothed rack should be as free as possible of play, in particular because otherwise noise is generated in the toothing arrangement engagement in the case of straight-ahead travel or reversal of the loading direction.

The steering play is also disadvantageous for the driving behavior of a motor vehicle. In order to bring about play-free engagement, the toothed rack is usually pressed against the pinion by a spring-loaded thrust piece. The thrust piece itself bears against the surface, facing away from the toothing arrangement, of the toothed rack and is seated in a generally cylindrical bore in the steering housing. Examples of known pressure mechanisms are, for example, specified in European patent applications EP 0 758 605 A1 and EP 0 860 345 A3.

Thrust pieces are costly in terms of fabrication and mounting. A separate connector is necessary on the steering housing. The thrust piece has to be provided with a spring and an adjustment screw as well as a locking nut for securing the adjustment screw. It must be very precisely adapted to the toothed rack and the connector in terms of shape. Furthermore, the thrust piece must be lubricated and adjusted. This is a considerable expenditure which also contributes to the costs of such a steering system. Nevertheless, at present virtually all rack and pinion steering systems are provided with a thrust piece.

Another technical solution without a thrust piece is known from DE 10 2009 014 671 A1. In said document, an eccentric sliding bearing of the toothed rack is provided which is rotatable with respect to the steering housing, with the result that the toothed rack can be adjusted in the direction of the steering pinion. It is therefore possible to adjust the toothed rack toward the pinion by rotating the bearing during the mounting of the steering gear, with the result that the play in this toothing arrangement engagement can be adjusted. A disadvantage of this technical solution is that although the adjustment of the play is possible, no elastic prestress which yields under load is generated.

The object of the present invention is therefore to improve a rack and pinion steering system without a thrust piece of the design mentioned at the beginning in such a way that play-free engagement between the pinion and the toothed rack with elastic prestress can be achieved.

This object is achieved by means of a rack and pinion drive having the features of claim 1.

Accordingly, a rack and pinion drive having a steering housing without a thrust piece connector is provided, wherein a toothed rack is slidably mounted in the steering housing, and having a pinion which is rotatably mounted in a bearing in a housing having a longitudinal axis, and which pinion has a pinion toothing arrangement which engages with a toothing arrangement of the toothed rack, in which a bearing arrangement mounts the bearing of the pinion in the housing, wherein the bearing arrangement has a guide piece which is arranged in abutment against the housing and has an internal guide face, and a sliding piece which surrounds the bearing and has an external guide face, wherein the sliding piece is guided so as to be slidable in the direction of the longitudinal axis of the housing by means of the guide faces, with the result that the pinion can be adjusted in the direction of the toothed rack.

It is particularly advantageous here if the bearing arrangement is elastically prestressed in the longitudinal direction. As a result of the prestress, the bearing arrangement yields under load and can therefore absorb inaccuracies in the toothing arrangement or shocks, generated for example by unevennesses in the roadway.

Furthermore, there is preferably provision that the guide faces are embodied optimized in terms of sliding, with the result that no self-locking occurs.

In this context, in the usable state the guide faces are in abutment with one another.

In one preferred embodiment, the guide faces are described by a part of a tilted, circular cylinder whose axis is tilted with respect to the longitudinal axis of the housing for engagement of the pinion in the toothed rack. It is therefore possible to adjust the play in the pinion/toothed rack engagement by using the guiding means.

Furthermore, it is advantageous if the guide faces are described by two so-called “gothic arches”. This type of embodiment forms a guide rail and therefore an additional anti-rotation protection between the guide piece and the sliding piece.

The bearing arrangement is advantageously prestressed in the longitudinal direction by a spring element.

In this context, the spring element is preferably embodied as a disk spring or helical spring.

In order to adjust the play of the engagement of the pinion toothing arrangement with the toothing arrangement of the toothed rack, an adjustment screw is preferably provided.

In order to compensate for angular errors which possibly occur as a result of the adjustment of play, it is possible to provide that the pinion is mounted so as to be pivotable in a small angular range at its end facing away from the bearing in a roller bearing which is embodied as a pendulum bearing, pivoting bearing, ball bearing or spherical roller bearing.

Two preferred embodiments of the invention are explained in more detail below with reference to the drawings, in which:

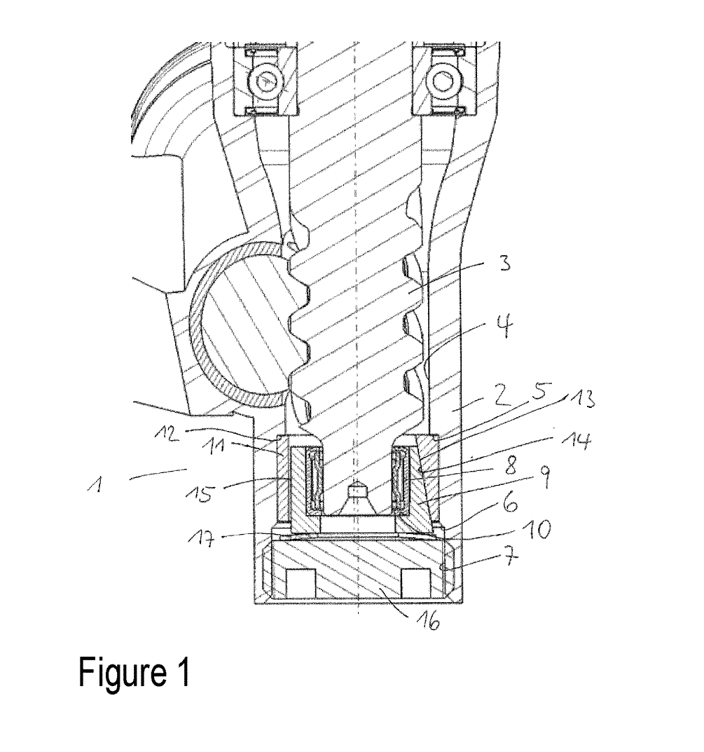

FIG. 1: shows a longitudinal section through an inventive bearing arrangement of a pinion of a toothed rack steering system,

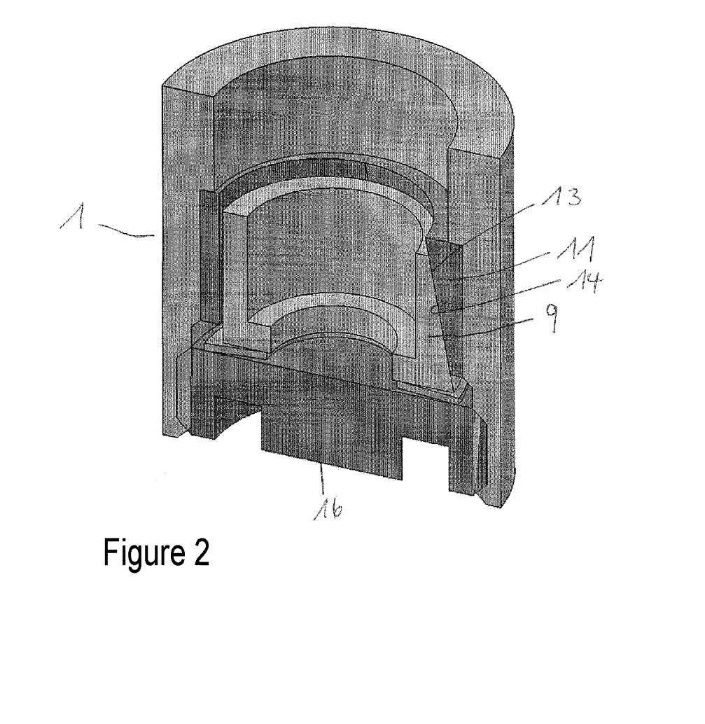

FIG. 2: shows a perspective view of the inventive bearing arrangement from FIG. 1 without illustration of the pinion,

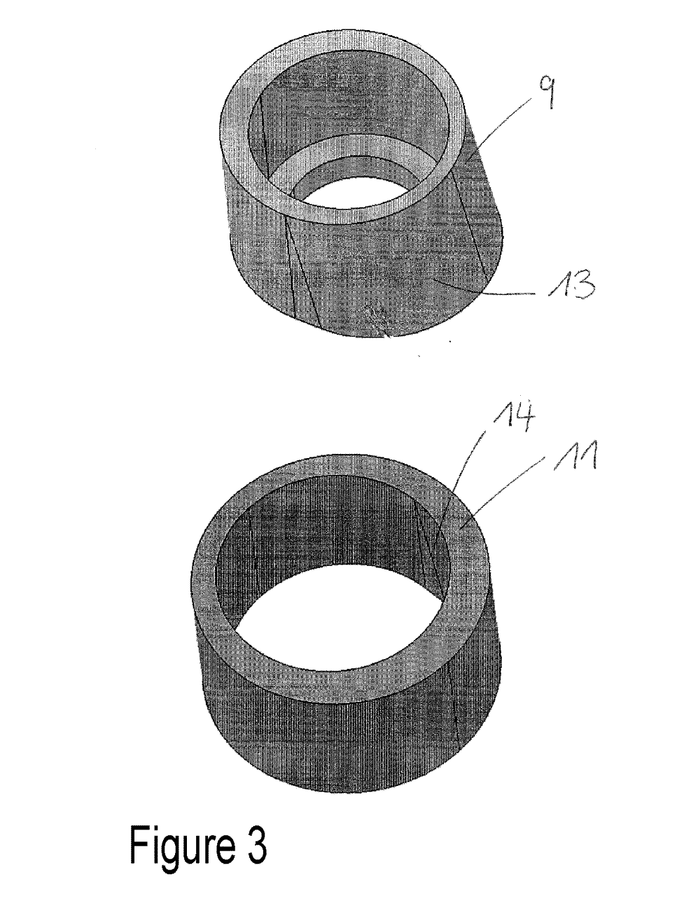

FIG. 3: shows a perspective view of individual parts of the bearing arrangement from FIG. 1 and FIG. 2,

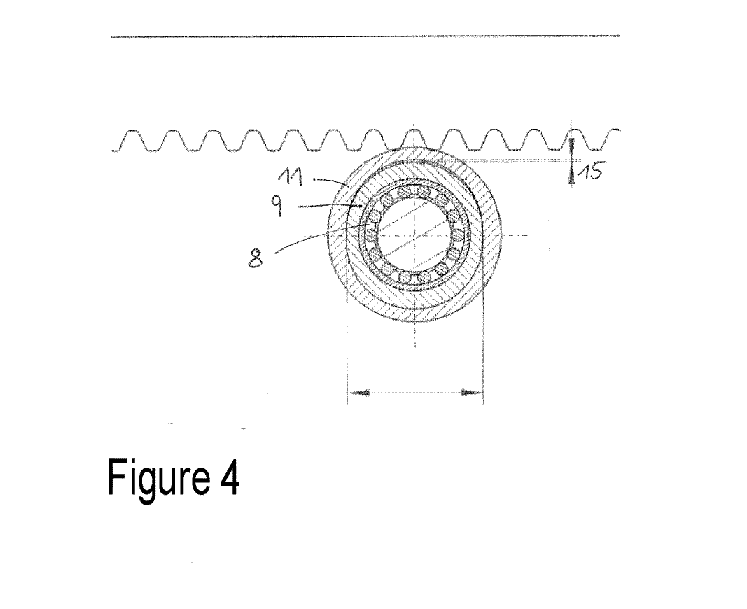

FIG. 4: shows a cross section through the inventive bearing arrangement, and

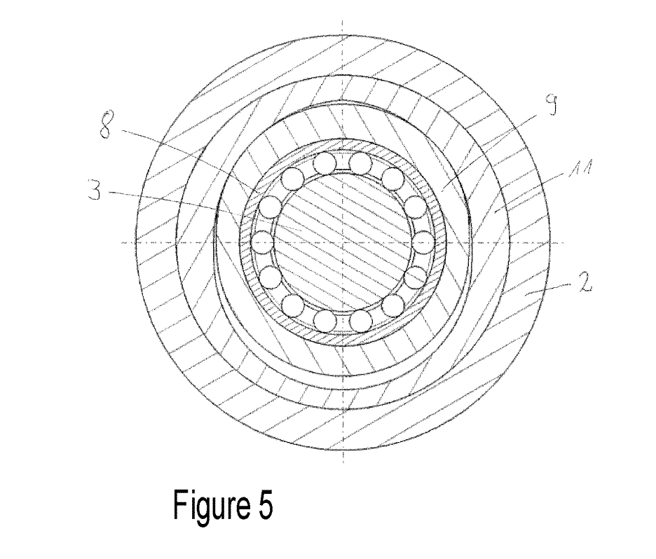

FIG. 5: shows a cross section through a further inventive bearing arrangement.

In FIG. 1, an inventive bearing arrangement 1 is illustrated at a free end of a pinion 3 which is mounted in a housing 2. The pinion 3 engages in the toothing arrangement of a toothed rack without play and brings about lateral displacement of the toothed rack in the event of rotation of the drive, for example the steering column or an electric motor, which is connected in a rotationally fixed fashion to the pinion, said toothed rack bringing about, in turn, pivoting of the steered wheels of the motor vehicle via steering track rods and steering knuckles.

The housing 2 has a cutout 4 which passes concentrically through said housing, along its longitudinal axis and has, at its end which is remote from the drive, a first shoulder 5 and a second shoulder 6 which are adjoined by an internal thread 7. In the cutout 4 of the housing 2, the pinion 3 is arranged longitudinally and is rotatably mounted at its end remote from the drive in a needle bearing 8. The cylindrical needle bearing 8 surrounds the end, remote from the drive, of the pinion 3 concentrically. The needle bearing 8 is in turn surrounded in an abutting fashion by a first sleeve 9 and is seated there in a bearing seat. The level of the first sleeve 9 is higher than the level of the needle bearing 8, and the first sleeve 9 is arranged in such a way that it projects beyond the cylindrical needle bearing 8 on the end side which is near to the drive and on the end side which is remote from the drive. In this context, the first sleeve 9 has, on the end side which is remote from the drive, a projection 10 which is directed radially inward and with which the needle bearing 8 abuts against its end side which is remote from the drive. The first sleeve 9 is also surrounded by a second sleeve 11, wherein the levels of the two sleeves 9, 11 are dimensioned to be approximately the same. The second sleeve 11 is arranged here in such a way that it bears with an end side, near to the drive, against an annular collar 12 on the first shoulder 5 of the cutout 4 in the housing 3 and projects radially beyond it in the inward direction, and with the inner side of the cutout 4 of the housing 3 it is in rotationally fixed abutment between the first shoulder 5 and the second shoulder 6 on the circumferential side. During mounting, the second sleeve 11 can be taken up by the end remote from the drive owing to the step-shaped cutout 4 in the housing 3 and pushed in as far as the annular collar 12. A fixed seat of the second sleeve 11 in the axial direction is therefore ensured. A rotationally fixed arrangement can be achieved, for example, through the interplay between a nose (not shown) on the second sleeve 11 with a corresponding recess in the inner side of the cutout 4 in the housing 3.

The two sleeves 9, 11 engage with one another, and in the process the second sleeve 11 acts as a guide piece which guides the first sleeve 9, the sliding piece, in an axially slidable fashion.

For axial sliding, the sleeves 9, 11 have parallel guide faces 13, 14 which are arranged on the outer side in the case of the first sleeve 9 and on the inner side in the case of the second sleeve 11, and a gap 15 which lies opposite the guide faces 13, 14 between the sleeves 9, 11.

In a direction which is remote from the drive, the second sleeve 11 is adjoined by the second shoulder 6 on the cutout 4, which shoulder has a relatively large diameter. This second shoulder 6 serves as a stop for an adjustment screw 16 which is screwed into the thread 7 of the housing 4. Furthermore, a spring element 17 is provided between the adjustment screw 16 and the first sleeve 9. The size of the spring element 17 is selected here such that the end side, remote from the drive, of the first sleeve 9 is in abutment with the spring element 17, and the spring element 17 projects outward beyond the first sleeve 9 in the radial direction. The spring element 17 can, as illustrated in FIG. 1, be embodied as a disk spring or alternatively also as a helical spring.

An axial force is applied to the first sleeve 9 by means of the spring element 17 which is supported on the adjustment screw 16. The resulting axial sliding of the first sleeve 9 with respect to the second sleeve 11 along the guide faces 13, 14 causes the pinion 3 to be moved perpendicularly with respect to the longitudinal direction, as a result of which the pinion 3 is pressed onto the toothed rack. The play of the toothing arrangement on the pinion 3 and toothed rack can therefore be adjusted by means of the adjustment screw 16.

FIG. 2 shows the bearing arrangement 1 without a pinion and without a needle bearing. The interplay of the first sleeve 9 with the second sleeve 11 can be clearly seen. The guide faces 13, 14 on the two sleeves 9, 11 form a guiding means which predefines the direction of movement of the first sleeve 9 with respect to the second sleeve 11. The guide faces 13, 14, bearing one against the other, of the sleeves 9, 11 are optimized here in terms of sliding in such a way that no self-locking occurs. Therefore, the bearing arrangement 1 can absorb, for example, even axial shocks of the pinion (not illustrated) counter to the spring force of the spring element 17 without jamming, wherein after the shock the initial position of the bearing arrangement 1 is assumed again through resetting of the spring element 17.

The shaping of the two sleeves 9, 11 is shown in FIG. 3. The first sleeve 9 and the second sleeve 11 have a straight circular-cylindrical shape over approximately 180° of their circumference, wherein the internal radius of the second sleeve 11 is larger than the external radius of the first sleeve 9, with the result that play is produced. This play in the form of the gap 15 permits the movement of the pinion perpendicularly with respect to the longitudinal axis respectively the axial sliding of the first sleeve 9 with respect to the second sleeve 11. Furthermore, the outer side of the first sleeve 9 has the first guide face 13, and the inner side of the second sleeve 11 has the second guide face 14. The inner side of the first sleeve 9 and the outer side of the second sleeve 11 are also embodied in a straight circular-cylindrical shape in the region of the guide faces 13, 14. In contrast, the outer side of the first sleeve 9 and the inner side of the second sleeve 11 are embodied in a tilting circular-cylindrical shape, wherein the axis is tilted in the direction of the engagement between the pinion and the toothed rack with respect to the longitudinal axis of the housing. The first guide face 13 and the second guide face 14 are matched to one another here in such a way that they are in abutment.

In further embodiments, the guide faces 13, 14 can be embodied in virtually any desired way, wherein they are always matched to one another in such a way that no self-locking of the guiding means occurs. For example, the guiding means can be described by two gothic arches (see FIG. 5). Gothic arches have the advantage that their design and the interplay between the guiding piece and the guided first sleeve produces a type of anti-rotation protection which ensures that the first sleeve does not rotate with respect to the second sleeve in the guiding means.

FIG. 4 shows the arrangement of the first sleeve 9, second sleeve 11 and needle bearing 8 in a cross section. The needle bearing 8 is received in abutment in the first sleeve 9. The gap 15, which permits the movement of the first sleeve 9 in the guide piece, can be seen between the first sleeve 9 and the second sleeve 11.

The two sleeves 9, 11 are preferably manufactured as sintered parts or injection molded parts.

During the mounting, the play is adjusted by means of the adjustment screw. The adjustment screw applies an axial force to the first sleeve in which the roller bearing of the pinion is seated. Through the guidance of the first sleeve which is inclined in the direction of the engagement between the pinion and the toothed rack, the pinion is forced against the toothed rack by the axially applied force, with the result that the engagement can be adjusted without play. During operation, the elastic prestress of the inventive bearing arrangement absorbs inaccuracies in the toothing arrangement. Furthermore, the pinion can avoid the shocks, for example generated by unevennesses in the roadway, wherein the spring element ensures resetting into the play-free state. In addition, reversal of the steering direction can be carried out without problems.

The bearing arrangement according to the invention permits the engagement between the pinion and the toothed rack to be achieved without a conventional thrust piece and with simple and cost-effective means without play and with elastic prestress.

1.-11. (canceled)

12. A rack and pinion drive comprising:
a housing without a thrust piece connector;
a toothed rack that has a toothing arrangement and is slidably mounted in the housing;
a pinion rotatably mounted in at least one bearing in the housing, the pinion being positioned along a longitudinal axis, wherein the pinion has a toothing arrangement that engages with the toothing arrangement of the toothed rack; and
a bearing arrangement for mounting the at least one bearing in the housing, wherein the bearing arrangement comprises:
a guide piece that abuts the housing and has an internal guide face, and
a sliding piece that surrounds the bearing and has an external guide face,
wherein the external guide face of the sliding piece is guided at least by the internal guide face of the guide piece such that the sliding piece that surrounds the bearing in which the pinion is rotatably mounted is slidable at least in a direction of the longitudinal axis, wherein the pinion is adjustable in a direction of the toothed rack.

13. The rack and pinion drive of claim 12 wherein adjustment of the pinion in the direction of the toothed rack comprises movement of the pinion perpendicular to the longitudinal axis.

14. The rack and pinion drive of claim 12 wherein the bearing arrangement is elastically prestressed in the longitudinal direction.

15. The rack and pinion drive of claim 12 wherein the guide piece and the sliding piece comprise circular cylinders with axes that are tilted with respect to the longitudinal axis.

16. The rack and pinion drive of claim 15 wherein at least a portion of the internal guide face and the external guide face are tilted with respect to the longitudinal axis.

17. The rack and pinion drive of claim 12 wherein at least a portion of the internal guide face and the external guide face are tilted with respect to the longitudinal axis.

18. The rack and pinion drive of claim 12 wherein in a usable state the internal guide face abuts the external guide face.

19. The rack and pinion drive of claim 12 wherein the internal and external guide faces comprise two gothic arches.

20. The rack and pinion drive of claim 12 wherein the bearing arrangement is prestressed in the longitudinal direction by a spring element.

21. The rack and pinion drive of claim 20 wherein the spring element comprises either a disk spring or a helical spring.

22. The rack and pinion drive of claim 12 further comprising an adjustment screw for adjusting a degree of engagement between the toothing arrangements of the pinion and the rack.

23. The rack and pinion drive of claim 22 wherein the adjustment screw is coupled to a spring that is coupled to the sliding piece, with the adjustment screw acting on the spring and the sliding piece so as to adjust the degree of engagement between the toothing arrangements of the pinions and the rack.

24. The rack and pinion drive of claim 12 wherein the pinion is pivotably mounted at an end of the pinion distal the bearing.

25. The rack and pinion drive of claim 24 wherein the end of the pinion that is pivotably mounted is pivotably mounted in a roller bearing comprising a pendulum bearing, a pivoting bearing, a ball bearing, or a spherical roller bearing.

26. A rack and pinion drive comprising:
a housing without a thrust piece connector;
a toothed rack that has a toothing arrangement and is slidably mounted in the housing;
a pinion rotatably mounted in the housing, the pinion being positioned along a longitudinal axis, wherein the pinion has a toothing arrangement that engages with the toothing arrangement of the toothed rack;
a bearing for rotatably mounting the pinion in the housing;
a guide piece that abuts the housing and has an internal guide face; and
a sliding piece that surrounds the bearing and has an external guide face, wherein the external guide face of the sliding piece is guided at least by the internal guide face of the guide piece such that the pinion is adjustable in a direction of the toothed rack.

27. The rack and pinion drive of claim 26 wherein the internal guide face and the external guide face are configured so as to cause the sliding piece to move diagonally with respect to the longitudinal axis.

28. The rack and pinion drive of claim 26 wherein the internal guide face and the external guide face are configured so as to cause the pinion to at least move perpendicular to the longitudinal axis such that proximity between the toothing arrangements of the rack and the pinion is adjustable.

29. The rack and pinion drive of claim 26 wherein only a portion of the internal and external guide faces are tilted with respect to the longitudinal axis.

30. The rack and pinion drive of claim 26 wherein angles of the internal and external guide faces taken with respect to the longitudinal axis vary across peripheries of the guide piece and the sliding piece.

31. A rack and pinion drive comprising:
a toothed rack that has a toothing arrangement and is slidably mounted in a housing;
a pinion that is slidable and rotatable and is positioned along a longitudinal axis, the pinion having a toothing arrangement that engages with the toothing arrangement of the toothed rack; and
a bearing arrangement for slidably and rotatably mounting the pinion to the housing, wherein a spring and/or an adjustment screw are configured to act on the bearing arrangement so as to control movement of the toothed rack both along the longitudinal axis and perpendicular to the longitudinal axis.
